(19) United States
(12) Patent Application Publication
(10) Pub. No.: US 2006/0213016 A1
(43) Pub. Date: Sep. 28, 2006

(54) Water-soluble fiber reactive dyes, their preparation and their use

(75) Inventors: Gunter Gorlitz, Sulzbach/Ts. (DE); Werner Russ, Florsheim-Wicker (DE)

Correspondence Address: CONNOLLY BOVE LODGE & HUTZ, LLP, P O BOX 2207, WILMINGTON, DE, 19899, US

(73) Assignee: DyStar Textilfarben GmbH & Co. Deutschland KG, Frankfurt am Main (DE)

(21) Appl. No.: 11/384,691

(22) Filed: Mar. 20, 2006

(30) Foreign Application Priority Data
Mar. 26, 2005 (DE) 10 2005 013 959.0

(51) Int. Cl. C09B 62/00

(52) U.S. Cl. 8/549

(57) ABSTRACT

The present invention relates to dyes of the general formula (1): 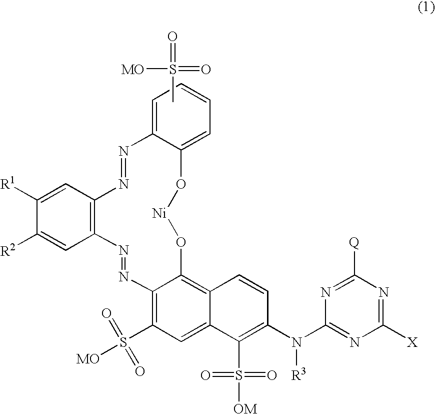
where R¹ to R³, M, X and Q are each as defined in claim 1, processes for their preparation and their use.

This invention resides in the technical field of fiber-reactive azo dyes.

The OPI document DE-A 3516667 describes green to olive metal complex dyes useful as reactive dyes for cotton, wool or nylon. They have certain performance defects, for example an excessive dependence of the color yield on changeable parameters in the dyeing operation or an inadequate or unlevel color buildup on cotton. Good color buildup refers to the ability of a dye to provide a stronger dyeing when used in a higher concentration in the dyebath. These dyes further exhibit unsatisfactory washfastnesses and only unsatisfactory fixation yields, i.e., the portion of dye permanently fixed to the material to be dyed is too low, especially at low temperatures.

However, it is important, for ecological and economical reasons, to provide dyes having particularly high fixation yields in order that the portion of unfixed dye in the dyehouse effluent may be minimized. Moreover, dyes should always provide uniformly strong dyeings, ideally regardless of changing dyeing parameters, for example the dyeing temperature in the dyeing operation. Furthermore, washfastness requirements are more stringent these days.

WO 02/08342 A1 describes dyes which largely solve the problems mentioned but do not cover the desired color space. Coverage of the color space is typically achieved through the use of dye mixtures which, however, compared with monomolecular chromophores, often exhibit a pronounced parametric dependence during dyeing. The advantage of monomolecular chromophores is that, even when dyeing parameters change, it is always the same colored molecule which goes on the fiber, whereas in the case of mixtures of a plurality of dyes various dyes may go on at different rates at different dyeing conditions and so may yield different hues on the substrate in each case.

The present invention now provides dyes of the hereinbelow defined general formula (1) which surprisingly afford distinctly superior washfastnesses than those described in DE-A 3516667. Moreover, these dyes have higher fixation yields and a distinctly lower parametric dependence during dyeing. They are therefore also more compatible with other dyes which fix at distinctly lower temperatures. In particular, however, the dyes of the general formula (1) are able to cover a larger color space than dyes described in DE-A 10035805.

The invention accordingly provides dyes of the general formula (1) 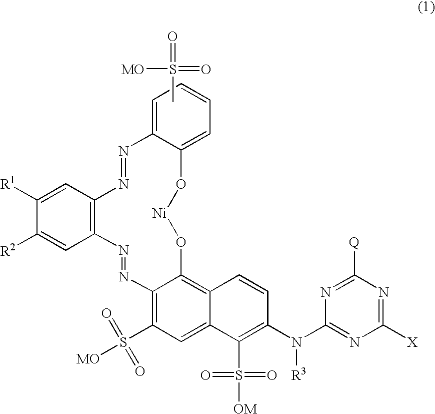
where
M is hydrogen, an alkali metal, the equivalent of an alkaline earth metal or ammonium;
X is halogen, for example fluorine or chlorine, C₁-C₄ alkoxy, for example methoxy or ethoxy, amino, C₁-C₄-alkylamino, N,N-(C₁-C₄)-dialkylamino, for example N,N-dimethylamino or N,N-diethylamino, anilino or sulfo- or hydroxyl-mono- or -disubstituted anilino or is a group of the formula (a), (b) (c) or (d) (a) (b) (c) (d) 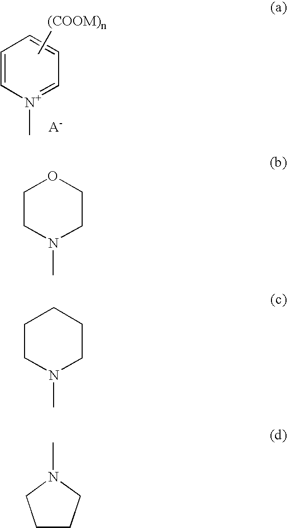
   where A⁻ is fluoride, chloride or the equivalent of a sulfate ion and n is 1 or 2;
R¹ and R² are independently C₁-C₆ alkyl, for example methyl, ethyl, n-propyl, i-propyl, n-butyl, i-butyl, sec-butyl, tert-butyl, pentyl or hexyl, C₁-C₆-alkoxy, for example methoxy, ethoxy, propyloxy or butyloxy, chlorine, C₁-C₄-alkylcarbonylamino, for example methylcarbonylamino, ethylcarbonylamino, propylcarbonyl-amino or butylcarbonylamino, arylcarbonylamino, for example phenylcarbonylamino, or combine to form a grouping of the formula (f) or (g) 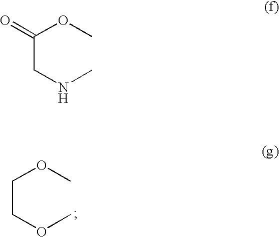
R³ is hydrogen or C₁-C₆-alkyl, for example methyl, ethyl, n-propyl, i-propyl, n-butyl, i-butyl, sec-butyl, tert-butyl, pentyl or hexyl;
Q is a grouping of the formula (e) 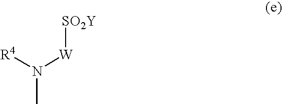
   where

R⁴ has one of the meanings of R³ or is phenyl or chlorine- or sulfo-substituted phenyl, W is C₂-C₆-alkylene which may be interrupted by 1 or 2 oxygen atoms or —NR⁵, where R⁵ has one of the meanings of R³ or is phenyl, and

Y is vinyl or a grouping of the formula CH₂CH₂Z, where Z is an alkali-eliminable grouping, for example chlorine, —OSO₃M, —S₂O₃M, OPO₃M₂, (C₂-C₅)-alkanoyloxy, for example acetyloxy, sulfobenzoyloxy, or a quaternary nitrogen group,

or when X is fluorine or chlorine is a group of the formula (a), (b), (c) or (d).

Q is particularly preferably a group of the formula (e) although when X is fluorine or chlorine the groups of the formulae (a) and (b) are also preferred.

Preferred meanings in the group of the formula (e) are hydrogen or methyl for R⁴, ethylene, propylene or 3-oxopentyl for W and vinyl or —CH₂CH₂OSO₃M for Y. Preferred compounds of the general formula (1) further include those in which

M is hydrogen, lithium, sodium or potassium,

X is fluorine or chlorine,

R¹ is methoxy,

R² is methoxy and/or

R³ is hydrogen or methyl.

Very particularly preferred compounds of the general formula (1) are those in which M, X, R¹ to R³ and Q each have the meanings identified above as preferred and particularly preferred, respectively.

Very particularly preferred compounds of the general formula (1) are accordingly for example those of the general formula (1a) 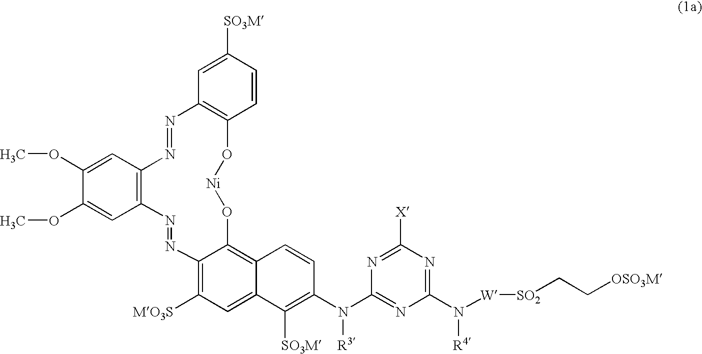
where
M′ is hydrogen, sodium or potassium;
X′ is fluorine or chlorine and
R^{3′} and R^{4′} are independently hydrogen or methyl and
W′ is ethylene, propylene or 3-oxopentyl.

Dyes of the general formula (1) according to the present invention which contain an —SO₂Z radical may differ with regard to the structure of the fiber-reactive group —SO₂Z while having otherwise the same structure. More particularly, —SO₂Z may be not only —SO₂CH═CH₂ but also —SO₂CH₂CH₂Z, more preferably β-sulfatoethylsulfonyl, while the structure is otherwise the same. The fraction of dye in vinylsulfonyl form may be up to 95 mol %, based on the respective dye chromophore. Preferably, the molar ratio of the vinylsulfonyl dye to β-ethyl-substituted dye is between 5:95 and 95:5.

The dyes of the general formula (1) according to the present invention can be present as a preparation in solid or liquid (dissolved) form. In solid form, they generally include the electrolyte salts customary for water-soluble and especially for fiber-reactive dyes, such as sodium chloride, potassium chloride and sodium sulfate, and they may further include the auxiliaries customary in commercial dyes, such as buffer substances capable of setting a pH in aqueous solution between 3 and 7, such as sodium acetate, sodium borate, sodium bicarbonate, sodium dihydrogenphosphate, sodium citrate and disodium hydrogenphosphate, or small amounts of siccatives; if they are present in liquid, aqueous solution (including the presence of thickeners of the type customary in printer pastes), they may also include substances which ensure a long life for these preparations, for example mold preventatives.

In general, the dyes of the general formula (1) according to the present invention are present as dye powders containing 10% to 80% by weight, based on the dye powder or the preparation, of an electrolyte salt which is also referred to as a standardizing agent. These dye powders may additionally include the aforementioned buffer substances in a total amount of up to 10% by weight, based on the dye powder. If the dyes of the present invention are present in aqueous solution, the total dye content of these aqueous solutions will be up to about 50% by weight, for example between 5% and 50% by weight, and the electrolyte salt content of these aqueous solutions will preferably be below 10% by weight, based on the aqueous solution; the aqueous solutions (liquid preparations) may include the aforementioned buffer substances in an amount which is generally up to 10% by weight and preferably up to 2% by weight.

The dyes of the general formula (1) according to the present invention may be constructed from suitable precursors by means of the diazotizing, coupling and metallizing reactions customary in dye chemistry and also reactions of trihalotriazine compounds with suitably substituted amines. These methods are familiar to one skilled in the art and they are exhaustively described in the pertinent literature.

For example, it is possible for a compound of formula (2) 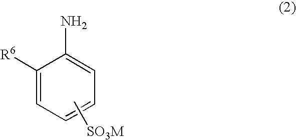
where R⁶ is halogen, for example chlorine, or C₁-C₄-alkoxy, for example methoxy, to be diazotized and coupled onto a compound of the formula (3) 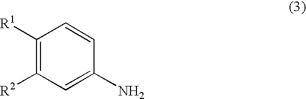
the resulting compound of formula (4) 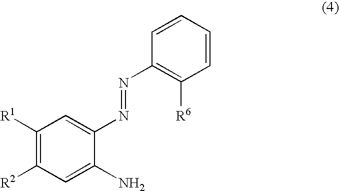
being diazotized and coupled onto a compound of the formula (5) 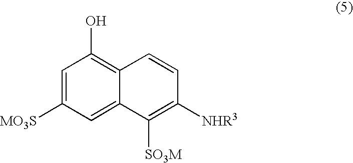
then the resulting compound of formula (6) 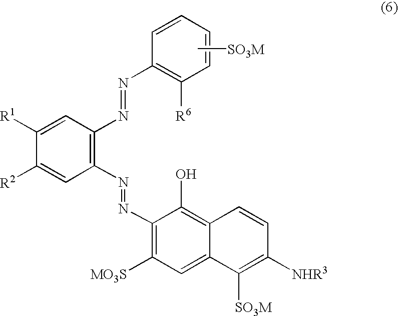
being reacted with a suitable nickel compound to form the chromophore of the formula (7) 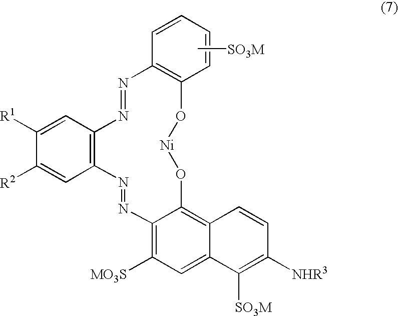
which is then reacted with a trihalotriazine of the formula (8) 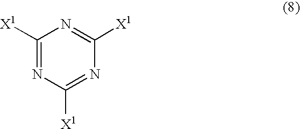
where X¹ is halogen, to form the compound of the formula (9) 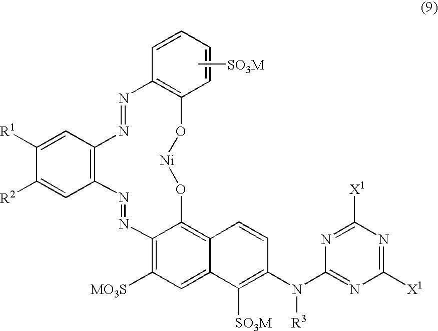
and then reacted with a compound of the formula H-Q to form the dye of the general formula (1), although in the event that X is not halogen the compound obtained must be additionally reacted with a compound H-X (where X is other than halogen).

The metallization may also be effected alternatively to the above-described process by the compound of the formula (4) being diazotized and then added to a suitable nickel compound and the coupling onto the compound of the formula (5) being carried out in the presence of ammonia, whereby, preferably by subsequent heating, the compound of the formula (7) is obtainable directly.

The diazotizing reactions are advantageously carried out with sodium nitrite in aqueous hydrochloric acid.

Examples of suitable nickel compounds are nickel salts such as nickel chloride, nickel sulfate and nickel sulfate hexahydrate. The reaction with the nickel salts mentioned is preferably carried out in the presence of ammonia at a temperature of 80 to 100° C.

The reaction of the compound of the formula (7) with the halotriazine of the formula (8) is preferably carried out in a neutral or weakly acidic medium at a temperature of about 0° C.

The separation and isolation of the compounds of the general formula (1) according to the present invention from the aqueous as-synthesized solutions can be effected by commonly known methods for water-soluble compounds, for example by precipitating from the reaction medium by means of an electrolyte, for example sodium chloride or potassium chloride, or by evaporating the reaction solution itself, for example by spray drying. When the last-mentioned form of isolating is chosen, it is often advisable for any sulfate quantities present in the solutions to be removed by precipitation as calcium sulfate and filtration before the evaporating.

The dyes of the general formula (1) according to the present invention have useful performance characteristics. They are used for dyeing or printing hydroxyl- and/or carboxamido-containing materials, for example in the form of sheetlike constructions, such as paper and leather or of films, for example composed of polyamide, or in the mass, as for example polyamide and polyurethane, but especially for dyeing or printing these materials in fiber form. Similarly, the solutions obtained for the dyes of the present invention in the course of the synthesis of the azo compounds can be used directly as a liquid preparation for dyeing, if appropriate after addition of a buffer substance, if appropriate also after concentrating or diluting.

The present invention thus also provides for the use of the dyes of the present invention for dyeing or printing these materials or to be more precise processes for dyeing or printing these materials in a conventional manner wherein dyes of the present invention are utilized as a colorant. The materials are preferably employed in the form of fiber materials, especially in the form of textile fibers, such as woven fabrics or yarns, as in the form of hanks or wound packages.

Hydroxyl-containing materials are those of natural or synthetic origin, for example cellulose fiber materials or their regenerated products and polyvinyl alcohols. Cellulose fiber materials are preferably cotton, but also other vegetable fibers, such as linen, hemp, jute and ramie fibers; regenerated cellulose fibers are for example staple viscose and filament viscose.

Carboxamido-containing materials are for example synthetic and natural polyamides and polyurethanes, especially in the form of fibers, for example wool and other animal hairs, silk, leather, nylon-6,6, nylon-6, nylon-11 and nylon-4.

The dyes of the general formula (1) according to the invention can be applied to and fixed on the substrates mentioned, especially the fiber materials mentioned, by the application techniques known for water-soluble dyes, especially fiber-reactive dyes. For instance, on cellulose fibers they produce by the exhaust method from a long liquor using various acid-binding agents and optionally neutral salts, such as sodium chloride or sodium sulfate, dyeings having very good washfastnesses. Application is preferably from an aqueous bath at temperatures between 40 and 105° C., optionally at a temperature of up to 130° C. under superatmospheric pressure, and optionally in the presence of customary dyeing auxiliaries. One possible procedure is to introduce the material into the warm bath and to gradually heat the bath to the desired dyeing temperature and to complete the dyeing process at that temperature. The neutral salts which accelerate the exhaustion of the dyes may also, if desired, only be added to the bath after the actual dyeing temperature has been reached.

The padding process likewise provides excellent color yields and very good color build-up on cellulose fibers, the dyes being allowed to become fixed on the material by batching at room temperature or at elevated temperature, for example at up to 60° C., by steaming or using dry heat in a conventional manner.

Similarly, the customary printing processes for cellulose fibers, which can be carried out either single-phase, for example by printing with a print paste comprising sodium bicarbonate or some other acid-binding agent and by subsequent steaming at 100 to 103° C., or two-phase, for example by printing with a neutral or weakly acidic print color and subsequent fixation either by passing the printed material through a hot electrolyte-comprising alkaline bath or by overpadding with an alkaline electrolyte-comprising padding liquor with subsequent batching of the alkali-overpadded material or subsequent steaming or subsequent treatment with dry heat, produce strong prints with well-defined contours and a clear white ground. The appearance of the prints is not greatly affected by variations in the fixing conditions.

When fixing by means of dry heat in accordance with the customary thermofix processes, hot air from 120 to 200° C. is used. In addition to the customary steam at 101 to 103° C., it is also possible to use superheated steam and high-pressure steam at temperatures of up to 160° C.

The acid-binding agents which effect the fixation of the dyes of the invention on the cellulose fibers include for example water-soluble basic salts of the alkali metals and likewise alkaline earth metals of inorganic or organic acids or compounds which liberate alkali in the heat. Especially suitable are the alkali metal hydroxides and alkali metal salts of weak to medium inorganic or organic acids, the preferred alkali metal compounds being the sodium and potassium compounds. Such acid-binding agents include for example sodium hydroxide, potassium hydroxide, sodium carbonate, sodium bicarbonate, potassium carbonate, sodium formate, sodium dihydrogenphosphate, disodium hydrogenphosphate, sodium trichloroacetate, waterglass or trisodium phosphate.

The cellulose dyeings obtained following the customary aftertreatment by rinsing to remove unfixed dye portions exhibit very good dye properties and provide by the application and fixing methods customary in the art for fiber-reactive dyes strong olive dyeings and prints having very good fastness properties, especially very good wash-, light-, alkali-, acid-, water-, seawater-, perspiration- and rubfastnesses, on the materials mentioned in the description, such as cellulose fiber materials, especially cotton and viscose. The dyeings are further notable for their high degree of fixation and good buildup on cellulose materials. Of particular advantage is the good washfastness of the dyeings, the high fixation value and the low temperature dependence compared with the prior art.

Furthermore, the dyes of the invention can also be used for the fiber-reactive dyeing of wool. Moreover, wool which has been given a nonfelting or low-felting finish (cf. for example H. Rath, Lehrbuch der Textilchemie, Springer-Verlag, 3rd Edition (1972), p. 295-299, especially the finish by the Hercosett process (p. 298); J. Soc. Dyers and Colourists 1972, 93-99, and 1975, 33-44) can be dyed with very good fastness properties.

The process of dyeing on wool is here carried out in a conventional manner from an acidic medium. For instance, acetic acid and/or ammonium sulfate or acetic acid and ammonium acetate or sodium acetate may be added to the dyebath to obtain the desired pH. To obtain a dyeing of acceptable levelness, it is advisable to add a customary levelling agent, for example on the basis of a reaction product of cyanuric chloride with 3 times the molar amount of an aminobenzenesulfonic acid and/or of an aminonaphthalenesulfonic acid or on the basis of a reaction product of for example stearylamine with ethylene oxide. For instance, the dyes of the invention are preferably subjected to the exhaust process initially from an acidic dyebath having a pH of about 3.5 to 5.5 under pH control and the pH is then, toward the end of the dyeing time, shifted into the neutral and optionally weakly alkaline range up to a pH of 8.5 to bring about, especially for very deep dyeings, the full reactive bond between the dyes of the invention and the fiber. At the same time, the dye portion not reactively bound is removed.

The procedure described herein also applies to the production of dyeings on fiber materials composed of other natural polyamides or of synthetic polyamides and polyurethanes. In general, the material to be dyed is introduced into the bath at a temperature of about 40° C., agitated therein for some time, the dyebath is then adjusted to the desired weakly acidic, preferably weakly acetic acid, pH and the actual dyeing is carried out at a temperature between 60 and 98° C. However, the dyeings can also be carried out at the boil or in sealed dyeing apparatus at temperatures of up to 106° C. Since the water solubility of the dyes of the invention is very good, they can also be used with advantage in customary continuous dyeing processes. The dyes of the invention dye the materials mentioned in green to olive shades.

The examples hereinbelow serve to illustrate the invention. Parts and percentages are by weight, unless otherwise stated. The compounds described in the examples in terms of a formula are partly indicated in the form of free acids; in general these compounds are prepared and isolated in the form of their salts, preferably sodium or potassium salts, and used for dyeing in the form of their salts. The starting compounds mentioned in the following examples can similarly be used in the synthesis in the form of the free acid or in the form of their salts, preferably alkali metal salts, such as sodium or potassium salts.

### EXAMPLE 1

a) 20.3 parts of 3-amino-4-methoxybenzenesulfonic acid are dissolved in 100 parts of water under neutral conditions, admixed with 30 parts of concentrated hydrochloric acid and 30 parts of ice. 6.9 parts of sodium nitrite in 100 parts of water are added with stirring and stirring is continued for 60 minutes. Excess nitrite is destroyed with sulfamic acid. 15.3 parts of 3,4-dimethoxyaniline are added and the pH is adjusted to 4.0 with 10% sodium carbonate solution in the course of 2 hours. The precipitated dye is filtered off with suction.

b) The dye prepared under a) is dissolved under neutral conditions, admixed with 6.9 parts of sodium nitrite and added dropwise with thorough stirring to a mixture of 180 parts of ice-water and 30 parts of concentrated hydrochloric acid. The mixture is subsequently stirred for 60 minutes and excess nitrite is destroyed with sulfamic acid. 27 parts of nickel sulfate hexahydrate are added to the reaction mixture obtained. The reaction mixture thus obtained is added to a solution of 31 parts of 5-hydroxy-1,7-disulfo-2-naphthylamine and 65 parts of 25% ammonia solution in 500 parts of ice-water.

c) The reaction solution obtained in b) is heated to 80-100° C. for 1-3 hours. The dye is then isolated at room temperature by addition of salt to obtain the chromophore of the formula (7a)

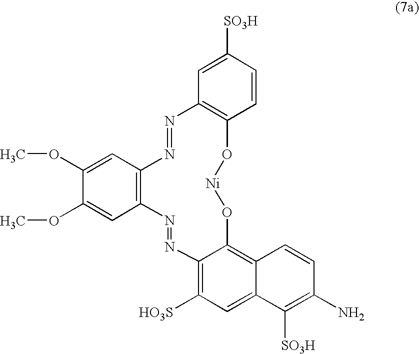

The compound of the formula (7a) can also be prepared in a similar manner by using 3-amino-4-chlorobenzenesulfonic acid.

The compound of the formula (7a) is dissolved under neutral conditions and desalted by pressure permeation.

d) The formula (7a) compound prepared under c) is dissolved under neutral conditions and mixed at 0° C. with 34.4 parts of trifluorotriazine by thorough stirring while pH 5 is maintained with 20% aqueous sodium hydroxide solution. The compound thus obtained has the formula (9a) 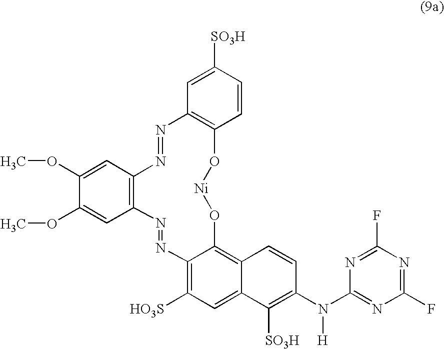
and is admixed after 10 minutes with a solution of 15 parts of N-methyl-N-(2-β-sulfatoethylsulfonyl)ethylamine while pH 6 is maintained with 20% sodium hydroxide solution. The reaction mixture is then allowed to come to room temperature. Salt is added to isolate the dye of the general formula (1b) according to the present invention.

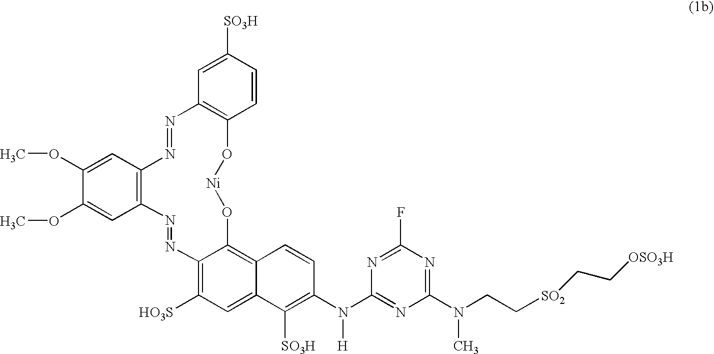

### EXAMPLE 2

The formula (7a) compound prepared according to Example 1 is dissolved in 100 parts of water under neutral conditions and reacted at 20-40° C. with 18.5 g of trichlorotriazine to form the compound of the formula (9b)

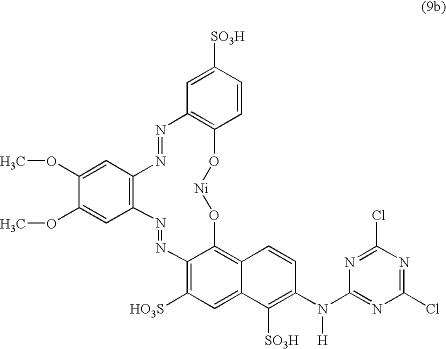

The pH of the reaction mixture is maintained by addition of 10% sodium carbonate solution. This is followed by the addition of 18 parts of the amine of the formula

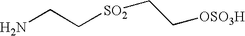

The dye solution obtained is concentrated by membrane desalting and spray dried to obtain the dye of the formula (1c) according to the present invention

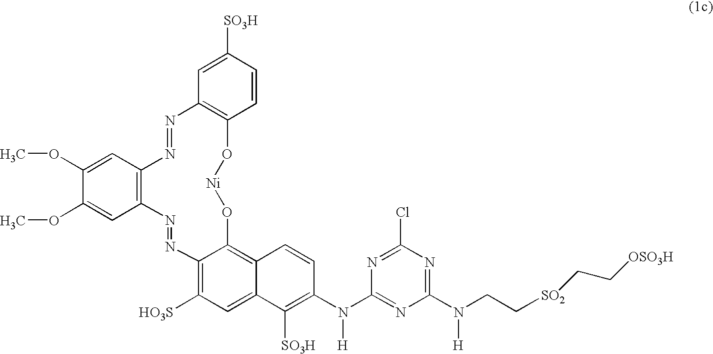

### EXAMPLE 3

The dye of the formula (1c) according to Example 2 is dissolved in water, adjusted to pH 11 with 20% aqueous sodium hydroxide solution at 0° C. and then adjusted to pH 7 with 31% hydrochloric acid to obtain the dye of the formula (1d) according to the present invention

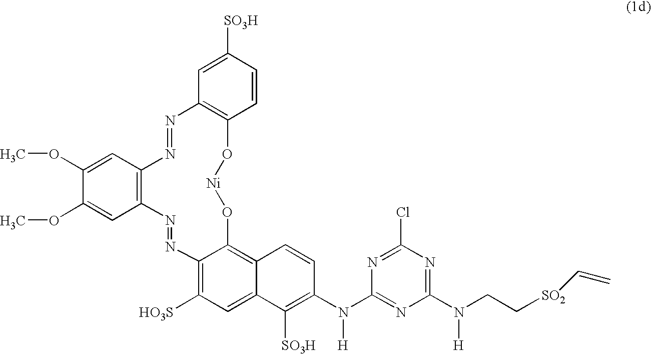

### EXAMPLE 4

Dye (1b) according to Example 1 is dissolved in water under neutral conditions, adjusted to pH 11 at 0° C. with 20% aqueous sodium hydroxide solution at 0° C., stirred for 30 minutes and then adjusted to pH 7 with 31% hydrochloric acid to obtain the dye of the formula (1e) according to the present invention

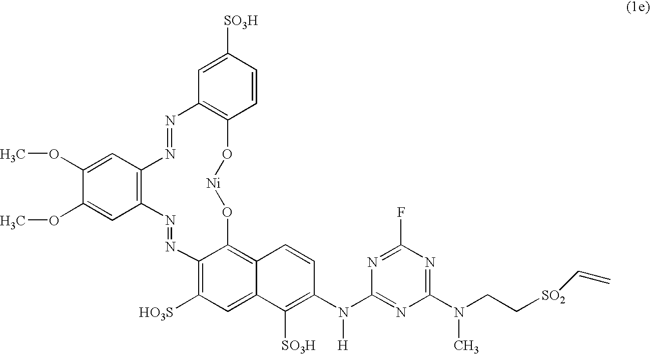

### EXAMPLE 5

The dye of the formula (1f) 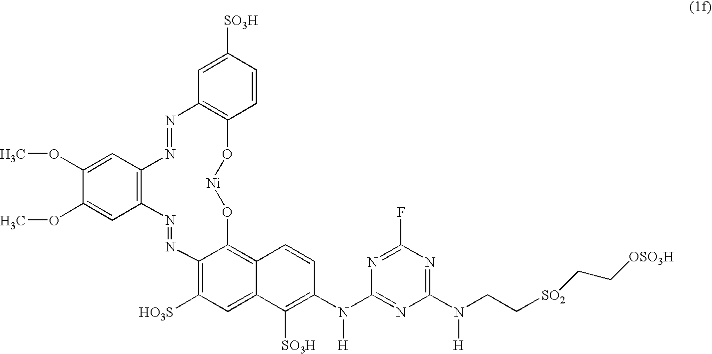
according to the present invention can likewise be prepared by following the directions in the preceding Examples 1 to 4.

### EXAMPLE 6

The dye of the formula (1g) 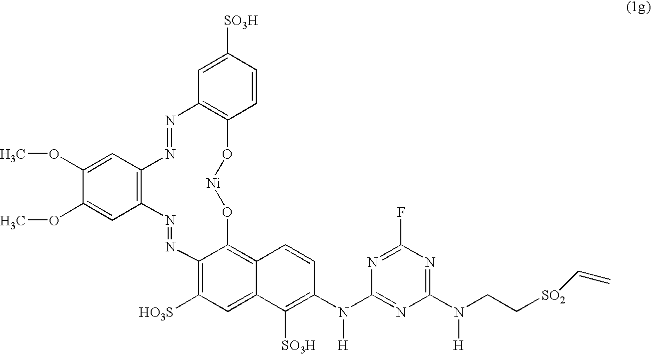
according to the present invention can likewise be prepared by following the directions in the preceding Examples 1 to 4.

### EXAMPLE 7

Two parts of the dye of the formula (1e) according to Example 4 are dissolved in 400 parts of water. 20 parts of sodium chloride, 8 parts of sodium carbonate and 20 parts of cotton fabric are added and heated to 60° C. in a dyeing machine over 25 minutes. Dyeing is performed at 60° C. for 60 minutes. The cotton fabric is subsequently rinsed with water and dilute acetic acid and dried to obtain a green dyeing having good lightfastness.

1. A dye of the general formula (1) 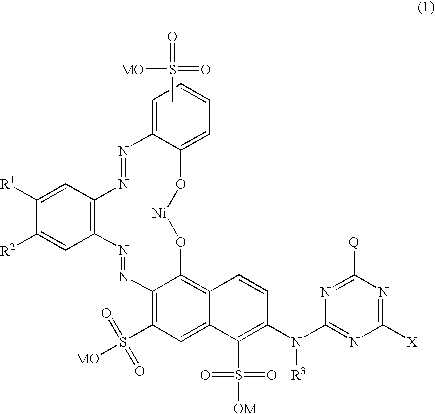
where
M is hydrogen, an alkali metal, the equivalent of an alkaline earth metal or ammonium;
X is halogen, C₁-C₄ alkoxy, amino, C₁-C₄-alkylamino, N,N-(C₁-C₄)-dialkylamino, anilino or sulfo- or hydroxyl-mono- or -disubstituted anilino or is a group of the formula (a), (b) (c) or (d) 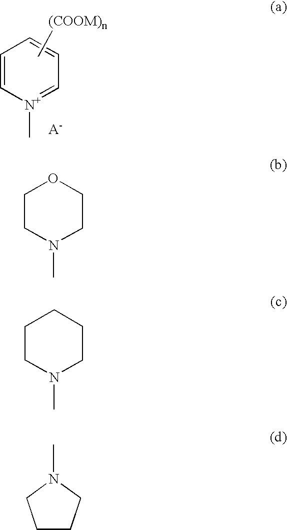
where A⁻ is fluoride, chloride or the equivalent of a sulfate ion and n is 1 or 2;
R¹ and R² are independently C₁-C₆ alkyl, C₁-C₆-alkoxy, chlorine, C₁-C₄-alkylcarbonylamino or arylcarbonylamino, or combine to form a grouping of the formula (f) or (g) 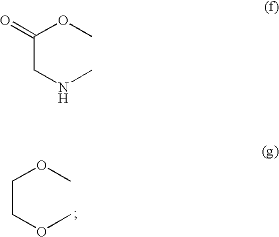
R³ is hydrogen or C₁-C₆-alkyl;
Q is a grouping of the formula (e) 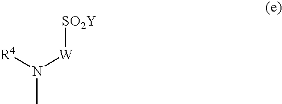
where
R⁴ has one of the meanings of R³ or is phenyl or chlorine- or sulfo-substituted phenyl,
W is C₂-C₆-alkylene which may be interrupted by 1 or 2 oxygen atoms or —NR⁵, where R⁵ has one of the meanings of R³ or is phenyl, and
Y is vinyl or a grouping of the formula CH₂CH₂Z, where Z is an alkali-eliminable grouping, or when X is fluorine or chlorine is a group of the formula (a), (b), (c) or (d).

2. A dye as claimed in claim 1, wherein
M is hydrogen, lithium, sodium or potassium,
X is fluorine or chlorine,
R¹ is methoxy,
R² is methoxy or
R³ is hydrogen or methyl.

3. A dye as claimed in claim 1, wherein
M is hydrogen, lithium, sodium or potassium,
X is fluorine or chlorine,
R¹ is methoxy,
R² is methoxy and
R³ is hydrogen or methyl.

4. A dye as claimed in claim 1, wherein Q is a group of the formula (e).

5. A dye as claimed in claim 4, wherein in the group of the formula (e) R⁴ is hydrogen or methyl, W is ethylene, propylene or 3-oxopentyl and Y is vinyl or CH₂CH₂OSO₃M.

6. A dye as claimed in claim 1, wherein Q is a group of the formula (a) or (b).

7. A dye as claimed in claim 1 which has the formula (1a) 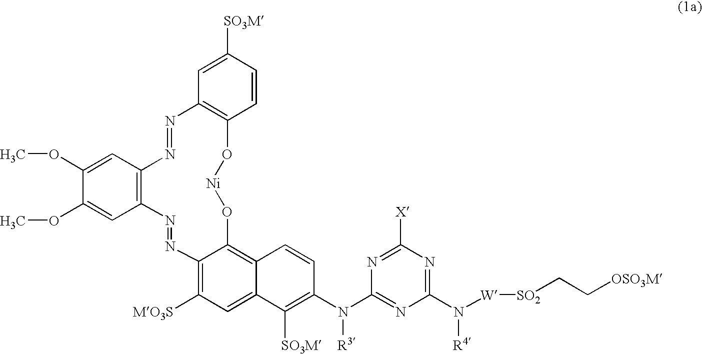
where
M′ is hydrogen, sodium or potassium;
X′ is fluorine or chlorine and
R^{3′} and R^{4′} are independently hydrogen or methyl and
W′ is ethylene, propylene or 3-oxopentyl.

8. A process for preparing a compound as claimed in claim 1, which comprises diazotizing and coupling a compound of the formula (2) 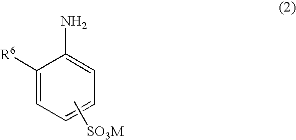
where R⁶ is halogen or C₁-C₄-alkoxy, onto a compound of formula (3) 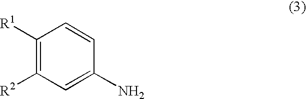
diazotizing and coupling the resulting compound of formula (4) 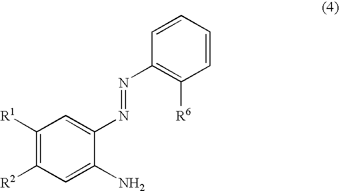
onto a compound of the formula (5) 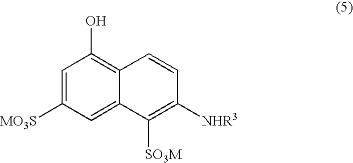
then reacting the resulting compound of formula (6) 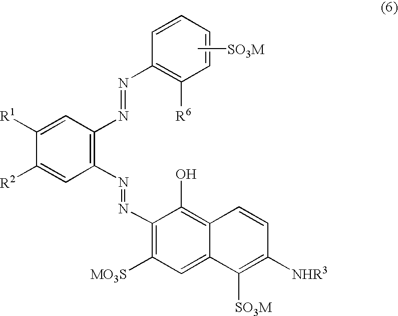
with a suitable nickel compound to form the chromophore of the formula (7) 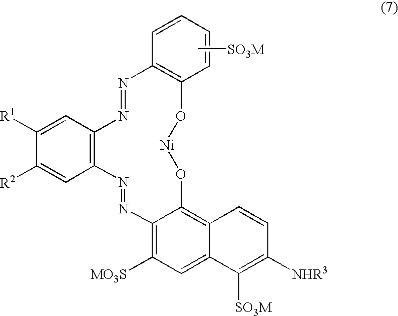
which is then reacted with a trihalotriazine of the formula (8) 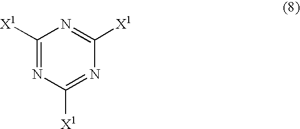
where X¹ is halogen, to form the compound of the formula (9) 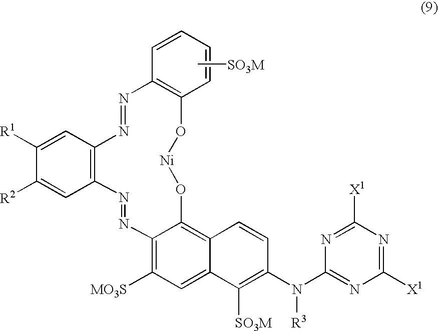
and then reacting with a compound of the formula H-Q to form the dye of the general formula (1), although in the event that X is not halogen the compound obtained is additionally reacted with a compound H-X (where X is other than halogen).

9. (canceled)

10. Hydroxyl- and/or carboxamido-containing material dyed or printed with a dye as claimed in claim 1.

11. A dye as claimed in claim 3, wherein Q is a group of the formula (e).

12. A dye as claimed in claim 11, wherein in the group of the formula (e) R⁴ is hydrogen or methyl, W is ethylene, propylene or 3-oxopentyl and Y is vinyl or CH₂CH₂OSO₃M.

13. A dye as claimed in claim 12, wherein Q is a group of the formula (a) or (b).
